(19) United States
(12) Patent Application Publication
(10) Pub. No.: US 2025/0207427 A1
(43) Pub. Date: Jun. 26, 2025

(54) VEHICLE-MOUNTED SUNSHADE DEVICE AND SUPPORT MECHANISM THEREOF

(71) Applicant: SHENZHEN YIJIA OUTDOOR PRODUCTS CO., LTD., SHENZHEN (CN)

(72) Inventor: QUNFEI HUANG, HENGYANG (CN)

(21) Appl. No.: 19/080,182

(22) Filed: Mar. 14, 2025

Related U.S. Application Data
(63) Continuation of application No. PCT/CN2023/087667, filed on Apr. 11, 2023.

(30) Foreign Application Priority Data
Sep. 15, 2022 (CN) 202211122959.3

(51) Int. Cl. E04H 15/08; E04H 15/48

(52) U.S. Cl. CPC E04H 15/08; E04H 15/48

(57) ABSTRACT

A vehicle-mounted sunshade device and a support mechanism thereof are provided. The vehicle-mounted sunshade device includes a storage housing, a roller for winding a sunshade cloth, and the support mechanism. The support mechanism supports the sunshade cloth when the sunshade cloth is in an unfolded state. The storage housing defines a limiting opening communicating the cover body with an outside. The support mechanism includes two folding assemblies respectively disposed on two opposite sides of the roller and a support assembly. Each of the folding assemblies includes a first folding arm, a second folding arm, a first rotating assembly, and a second rotating assembly. A pull rod fixedly connected to the support assembly is disposed on one side of the sunshade cloth away from the roller. The support mechanism simplifies unfolding and storage of the vehicle-mounted sunshade device, which is convenient to use and improves user experience.

### TECHNICAL FIELD

The present disclosure relates to a technical field of vehicle accessories, and in particular to a vehicle-mounted sunshade device and a support mechanism thereof.

### BACKGROUND

From perspective of energy saving and environmental protection, awnings play a significant role. When shielding strong sunlight, the awnings make strong sunlight shine into a room in a form of diffuse light, making indoor light bright without dazzling, allowing users to enjoy scenery outside windows from indoors, thereby expanding people's living space from indoors to outdoors and creating extra living space. A sunshade cloth of the awnings has an anti-ultraviolet function, which not only protects human skin from ultraviolet rays, but also greatly extends service life of interior decoration and furniture. With development of society, people's quality of life has gradually improved. More and more families like to drive around the city to camp and play during holidays. When people stop to rest, in order to shield the sun and prevent the ultraviolet rays from harming the human skin, or to protect against rain when it rains, people generally install an awning on one side of a car. Therefore, when people stop to rest, they only need to open the awning on the side of the car, and the awning plays a role in sun protection and rain protection. When people are ready to continue driving, they only need to put away the awning.

The awning installed on one side of the car in the prior art is either an electric awning or a manual awning. The electric awning is large in size and heavy in weight, which is generally installed on a roof of recreational vehicles (RVs) or commercial vehicles and is not suitable for family cars. The manual awning is small in size and light in weight, and is suitable for installation on ordinary family cars. However, during use, since the manual awning is more cumbersome to unfold and store, the user needs to slowly roll up the sunshade cloth to unfold or store the sunshade cloth. In addition, the user further needs to place side edges of the sunshade cloth into fixing grooves in a support rod to improve stability and wind resistance of the manual awning. When encountering special weather interference such as wind and rain, the sunshade cloth rises and falls under an action of external force, and it is difficult for the user to complete the opening or storage of the manual awning alone, affecting the user experience.

### SUMMARY

A purpose of the present disclosure is to provide a support mechanism of a vehicle-mounted sunshade device to solve a technical problem in the prior art that the vehicle-mounted sunshade device is complicated to open and store, and it is difficult for one person to complete the opening or storage of the vehicle-mounted sunshade device.

To achieve the above purpose, the present disclosure provides the support mechanism of the vehicle-mounted sunshade device. The vehicle-mounted sunshade device comprises a storage housing having a cover body, a roller rotatably disposed in the storage housing, a sunshade cloth wound on the roller, and the support mechanism. The support mechanism is configured to support the sunshade cloth when the sunshade cloth is in an unfolded state. The storage housing defines a limiting opening communicating the cover body with an outside and allowing the sunshade cloth and the support mechanism to pass through. The support mechanism comprises two folding assemblies respectively disposed on two opposite sides of the roller and a support assembly. Each of the folding assemblies comprises a first folding arm, a second folding arm, a first rotating assembly, and a second rotating assembly. The first folding arm and the second folding arm are rotatably disposed in the storage housing. The first rotating assembly is configured to rotatably connect the first folding arm to the second folding arm. The second rotating assembly is configured to rotatably connect the second folding arm to the support assembly. A pull rod fixedly connected to the support assembly is disposed on one side of the sunshade cloth away from the roller.

In one embodiment, the first rotating assembly comprises a first connecting joint disposed on an end portion of the first folding arm, a second connecting joint disposed on a first end portion of the second folding arm, and a first rotating shaft rotatably connected to the first connecting joint and the second connecting joint. The first connecting joint comprises a first connecting portion. The second connecting joint comprises two second connecting portions disposed at intervals. A first mounting area for placing the first connecting portion is enclosed between the two second connecting portions. The first connecting portion and the two second connecting portions comprise first through holes. The first rotating shaft passes through the first through holes.

In one embodiment, the first rotating assembly further comprises a locking assembly configured to limit a rotating range of the second folding arm. The second connecting joint comprises a first mounting hole communicating the first mounting area with an inner cavity of the second folding arm. The locking assembly is mounted in the first mounting hole.

The locking assembly comprises a locking rod and a locking bolt. The locking bolt runs through the second connecting joint and the locking rod, so that the locking rod is rotatable relative to the second connecting joint with the locking bolt as a rotation center. The locking rod is rotatable close to or away from the first connecting portion. The first connecting portion defines a limiting groove. A locking hook disposed on an end portion of the locking rod is placed in the limiting groove.

In one embodiment, the second folding arm comprises an inner retractable rod and an outer sleeving rod sleeved on an outer wall of the inner retractable rod. The outer sleeving rod is connected to the first folding arm. The inner retractable rod is connected to the support assembly.

In one embodiment, the first rotating assembly further comprises a limiting assembly. The limiting assembly is configured to drive the locking rod to rotate relative to the second connecting joint.

The limiting assembly comprises a sleeve disposed in the outer sleeving rod, a limiting bolt, and a first elastic piece disposed between the sleeve and the second connecting joint. The sleeve movably abuts against the inner retractable rod. The limiting bolt runs through the sleeve and the locking rod. The locking rod defines a kidney-shaped hole. The kidney-shaped hole is inclined. The limiting bolt passes through the kidney-shaped hole. The sleeve defines a second mounting hole configured for placing the locking rod.

In one embodiment, the second rotating assembly comprises a third connecting joint disposed on a second end portion of the second folding arm, a fourth connecting joint disposed on the support assembly, and a second rotating shaft. The second rotating shaft is rotatably connected to the third connecting joint and the fourth connecting joint. The third connecting joint comprises a third connecting portion. The fourth connecting joint comprises two fourth connecting portions disposed at intervals. A second mounting area for placing the third connecting portion is enclosed between the two fourth connecting portions. The third connecting portion and the two fourth connecting portions comprise second through holes. The second rotating shaft passes through the second through holes.

In one embodiment, the support assembly comprises a support frame rotatably connected to a second end portion of the second folding arm of each of the folding assemblies. At least one support rod is rotatably disposed on the support frame. The support frame defines an accommodating area configured to accommodate the at least one support rod.

In one embodiment, a connecting rod spring is disposed inside the first folding arm. A first end of the connecting rod spring is connected to a first connecting piece, and a second end of the connecting rod spring is connected to the second folding arm through the first folding arm.

Compared with the prior art, the support device is disposed on the vehicle-mounted sunshade device. The vehicle-mounted sunshade device comprises a storage housing having the cover body, the roller rotatably disposed in the storage housing, the sunshade cloth wound on the roller, and the support mechanism. The support mechanism is configured to support the sunshade cloth when the sunshade cloth is in the unfolded state. The storage housing defines the limiting opening communicate the cover body with the outside and allowing the sunshade cloth and the support mechanism to pass through. The support mechanism comprises the two folding assemblies and the support assembly. The two folding assemblies are respectively disposed on the two opposite sides of the roller.

Each of the folding assemblies comprises the first folding arm, the second folding arm, the first rotating assembly, and the second rotating assembly. The first folding arm and the second folding arm are rotatably disposed in the storage housing. The first rotating assembly is configured to rotatably connect the first folding arm to the second folding arm. The second rotating assembly is configured to rotatably connect the second folding arm to the support assembly. The pull rod fixedly connected to the support assembly is disposed on one side of the sunshade cloth away from the roller.

When the sunshade cloth needs to be unfolded for use, the user is able to pull the support assembly of the support mechanism to pull the support assembly out of the cover body from the limiting opening on the storage housing. While pulling the support assembly, the first rotating assembly and the second rotating assembly of each of the folding assemblies are pulled by the external force applied on the support assembly, and the first folding arm and the second folding arm of each of the folding assemblies disposed on the two opposite sides of the roller are rotated from a folded storage state to the unfolded state. At the same time, the pull rod disposed on the sunshade cloth and fixedly connected to the support assembly is driven by the support assembly to move out of the cover body. In addition, when the pull rod is pulled, the pull rod drives the sunshade cloth to rotate, thereby driving the roller to rotate, so that the sunshade cloth wound on the roller is pulled out of the cover body through the limiting opening. The two folding assemblies disposed on the opposite sides of the roller and the support assembly support and fix the sunshade cloth, and at this time the sunshade cloth plays a role of sunshade and rainproof.

When the sunshade cloth needs to be stored, the user only needs to pushes the support assembly so that the support assembly is placed into the cover body from the limiting opening of the storage housing. At this time, the first folding arm and the second folding arm of each of the folding assemblies that are disposed on the two opposite sides of the roller are rotated from the unfolded state to the folded storage state, and the sunshade cloth is rolled up on the roller under the push of the pull rod. In this way, the storage of the vehicle-mounted sunshade device is completed. At the same time, by providing the connecting rod spring in each of the folding assemblies, it is more labor-saving when folding or unfolding the sunshade cloth through the folding assemblies, so the unfolding and storage of the sunshade cloth is allowed to be completed by one person, which simplifies the operation, makes it easier for the user to use, and effectively improves the user experience.

To achieve the above purpose, the present disclosure further provides the vehicle-mounted sunshade device. In one embodiment, the storage housing comprises a cover body and mounting plates. The cover body comprises an upper cover. The upper cover is disposed above the mounting plates and is rotatable relative to the mounting plates.

The cover body further comprises upper cover spring seats and upper cover springs. The upper cover spring seats are disposed on the upper cover. An upper cover spring seat groove is defined in each of the upper cover spring seats. Each of the upper cover springs is connected to a corresponding one of the mounting plates. Each of the upper cover springs comprises an upper cover spring clamping portion. The upper cover spring clamping portion of each of the upper cover springs is matched with the upper cover spring seat groove of a corresponding one of the upper cover spring seats. When the upper cover rotates upward to an open position relative to the mounting plates, the upper cover spring clamping portion of each of the upper cover springs completely enters the upper cover spring seat groove of the corresponding one of the upper cover spring seats.

In one embodiment, the cover body further comprises upper cover buckles disposed on the upper cover. Upper cover switches are respectively disposed on the mounting plates. When the cover body is rotated downward relative to the mounting plates until the upper cover abuts against the mounting plates, each of the upper cover buckles is engaged with a corresponding one of the upper cover switches. The vehicle-mounted sunshade device further comprises a fixing plate disposed below the upper cover. The upper cover buckles comprises buckle anti-disengagement seats. When each of the upper cover buckles is engaged with the corresponding one of the upper cover switches, the buckle anti-disengagement seats abuts against the fixing plate.

In one embodiment, the upper cover switches are connected to the fixing plate through positioning columns.

Compared with the prior art, the upper cover spring clamping portion of each of the upper cover springs completely and the upper cover spring seat groove of the corresponding one of the upper cover spring seats not only form a clamping relationship, but also provide an upward support force for the upper cover, so that the upper cover is only allowed to rotate downward after the upper cover is subjected to a force that causes the upper cover spring clamping portion of each of the upper cover springs to disengage from the upper cover spring seat groove of the corresponding one of the upper cover spring seats. Therefore, even in severe weather such as strong winds and heavy rains, the upper cover is still stably supported and does not accidentally rotate downward nor being closed. At the same time, a buckle anti-disengagement seats are disposed on the upper cover buckles, so that when the upper cover is in a closed position, the upper cover is not accidentally open even if it is subjected to a large external force.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a perspective schematic diagram of a vehicle-mounted sunshade device according to one embodiment of the present disclosure.

FIG. 2 is another perspective schematic diagram of the vehicle-mounted sunshade device according to one embodiment of the present disclosure.

FIG. 3 is a partial perspective schematic diagram of a first rotating assembly of a support mechanism of the vehicle-mounted sunshade device according to one embodiment of the present disclosure.

FIG. 4 is a cross-sectional schematic diagram of a first embodiment of a folding assembly of the support mechanism of the vehicle-mounted sunshade device according to one embodiment of the present disclosure.

FIG. 5 is an enlarged schematic diagram of portion A shown in FIG. 4.

FIG. 6 is an enlarged schematic diagram of portion B shown in FIG. 4.

FIG. 7 is an exploded schematic diagram of a storage housing of the vehicle-mounted sunshade device according to one embodiment of the present disclosure.

FIG. 8 is an enlarged schematic diagram of portion C shown in FIG. 1.

FIG. 9 is a schematic diagram of an upper cover spring and an upper cover spring seat of the vehicle-mounted sunshade device according to one embodiment of the present disclosure.

FIG. 10 is a schematic diagram of an upper cover buckle of the vehicle-mounted sunshade device according to one embodiment of the present disclosure.

FIG. 11 is a schematic diagram of an upper cover switch of the vehicle-mounted sunshade device according to one embodiment of the present disclosure.

FIG. 12 is a cross-sectional schematic diagram of a second embodiment of the folding assembly of the vehicle-mounted sunshade device according to one embodiment of the present disclosure.

In the drawings:
1—storage housing; 11—cover body; 111—upper cover buckle; 111a—hook; 111b—buckle anti-disengagement seat; 112—upper cover spring seat; 112a—upper cover spring seat groove; 112b—upper cover spring seat block; 113—upper cover spring; 113a—upper cover spring clamping portion; 114—upper cover; 12—pull rod; 13—mounting plate; 131—upper cover switch; 131a—switch buckle; 131b—positioning column; 131c—switch button; 131d—switching spring; 14—mounting frame; 15—pull rod; 21—roller; 212—first reel; 213—gear; 214—reel spring; 215—reel fixing piece; 216—reel washer; 217—second reel; 221—first connecting rod; 222—second connecting rod; 224a—connecting hole; 225—connecting rod spring; 226—first connecting piece; 227—second connecting piece; 228—first mounting piece; 229—second mounting piece; 230—connecting rod spring screw; 231—connecting rod spring washer; 3—support mechanism; 31—folding assembly; 311—first folding arm; 312—second folding arm; 3121—inner retractable rod; 3122—outer sleeving rod; 313—first rotating assembly; 3131—first connecting joint; 31311—first connecting portion; 31312—limiting groove; 3132—second connecting joint; 31321—second connecting portion; 31322—first mounting hole; 3133—first rotating shaft; 314—second rotating assembly; 3141—third connecting joint; 3142—fourth connecting joint; 3143—second rotating shaft; 315—locking assembly; 3151—locking rod; 31511—locking hook; 31512—kidney-shaped hole; 3152—locking bolt; 316—limiting assembly; 3161—sleeve; 31611—second mounting hole; 3162—limiting bolt; 3163—first elastic piece; 32—support assembly; 321—support frame; 322—support rod.

### DETAILED DESCRIPTION

In order to make objectives, technical solutions, and advantages of the present disclosure clearer, the following further describes the present disclosure in detail with reference to accompanying drawings and embodiments. It should be understood that the specific embodiments described here are only used to explain the present disclosure, but not to limit the present disclosure.

It should be noted that when one component is referred to as being “fixed on” or “disposed on” another component, it can be directly disposed on the other component or it may be indirectly fixed or disposed on the other component through a third component. When one component is said to be “connected to” another component, it may be directly connected to the other component or it may be indirectly connected to the other component through a third component.

It should be understood that terms such as “length”, “width”, “upper”, “lower”, “front”, “rear”, “left”, “right”, “vertical”, “horizontal”, “top”, “bottom”, “inner”, “outer”,, etc., indicate direction or position relationships shown based on the drawings, and are only intended to facilitate the description of the present disclosure and the simplification of the description rather than to indicate or imply that the indicated device or element must have a specific direction or constructed and operated in a specific direction, and therefore, shall not be understood as a limitation to the present disclosure.

In addition, terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present disclosure, the meaning of “a plurality of” is two or more unless otherwise specified.

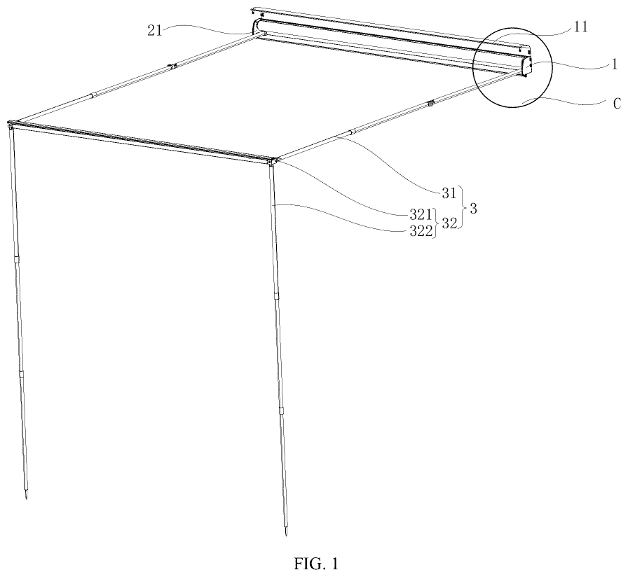

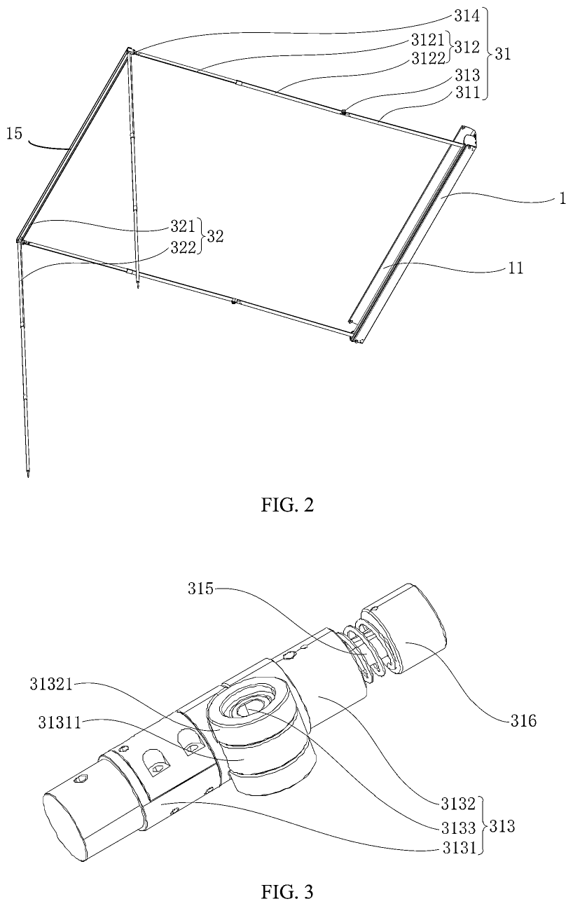

As shown in FIGS. 1-2, the present disclosure provides a support mechanism 3 of a vehicle-mounted sunshade device. The vehicle-mounted sunshade device comprises the storage housing 1 having a cover body 11, a roller 21 rotatably disposed in the storage housing 1, a sunshade cloth wound on the roller 21, and the support mechanism 3. The support mechanism 3 is configured to support the sunshade cloth when the sunshade cloth is in an unfolded state. The storage housing 1 defines a limiting opening communicating the cover body 11 with an outside and allowing the sunshade cloth and the support mechanism 3 to pass through. The support mechanism 3 comprises two folding assemblies 31 respectively disposed on two opposite sides of the roller 21 and a support assembly 32. Each of the folding assemblies 31 comprises a first folding arm 311, a second folding arm 312, a first rotating assembly 313, and a second rotating assembly 314. For ease of illustration, the present disclosure takes one of the folding assemblies for further description. The first folding arm 311 and the second folding arm are rotatably disposed in the storage housing 1. The first rotating assembly 313 is configured to rotatably connect the first folding arm 311 to the second folding arm. The second rotating assembly 314 is configured to rotatably connect the second folding arm to the support assembly 32. A pull rod horizontally and fixedly connected to the support assembly 32 is disposed on one side of the sunshade cloth away from the roller 21.

When the sunshade cloth needs to be unfolded for use, the user is able to pull the support assembly 32 of the support mechanism 3 to pull the support assembly 32 out of the cover body 11 from the limiting opening on the storage housing 1. While pulling the support assembly 32, the first rotating assembly 313 and the second rotating assembly 314 of each of the folding assemblies 31 are pulled by the external force applied on the support assembly 32, and the first folding arm 311 and the second folding arm of each of the folding assemblies 31 disposed on the two opposite sides of the roller 21 are rotated from a folded storage state to the unfolded state. At the same time, the pull rod disposed on the sunshade cloth and fixedly connected to the support assembly 32 is driven by the support assembly 32 to move out of the cover body 11. In addition, when the pull rod is pulled, the pull rod drives the sunshade cloth to rotate, thereby driving the roller 21 to rotate, so that the sunshade cloth wound on the roller 21 is pulled out of the cover body 11 through the limiting opening. The two folding assemblies 31 disposed on the opposite sides of the roller 21 and the support assembly 32 support and fix the sunshade cloth, and at this time the sunshade cloth plays a role of sunshade and rainproof.

When the sunshade cloth needs to be stored, the user only needs to pushes the support assembly 32 so that the support assembly 32 is placed into the cover body 11 from the limiting opening of the storage housing 1. At this time, the first folding arm 311 and the second folding arm of each of the folding assemblies 31 that are disposed on the two opposite sides of the roller 21 are rotated from the unfolded state to the folded storage state, and the sunshade cloth is rolled up on the roller 21 under the push of the pull rod. In this way, the storage of the vehicle-mounted sunshade device is completed. At the same time, by providing the connecting rod spring in each of the folding assemblies 31, it is more labor-saving when folding or unfolding the sunshade cloth through the folding assemblies 31, so the unfolding and storage of the sunshade cloth is allowed to be completed by one person, which simplifies the operation, makes it easier for the user to use, and effectively improves the user experience.

FIG. 3 is a partial perspective schematic diagram of the first rotating assembly 313 of the present disclosure. As shown in FIG. 3, the first rotating assembly 313 comprises a first connecting joint 3131 disposed on an end portion of the first folding arm 311, a second connecting joint 3132 disposed on a first end portion of the second folding arm, and a first rotating shaft 3133 rotatably connected to the first connecting joint 3131 and the second connecting joint 3132. The first connecting joint 3131 comprises a first connecting portion 31311. The second connecting joint 3132 comprises two second connecting portions 31321 disposed at intervals. A first mounting area for placing the first connecting portion 31311 is enclosed between the two second connecting portions 31321. The first connecting portion 31311 and the two second connecting portions 31321 comprise first through holes. The first rotating shaft 3133 passes through the first through holes.

By placing the first connecting portion 31311 of the first connecting joint 3131 into the first mounting area enclosed by the two second connecting portions 31321, and by passing the first rotating shaft 3133 through the first through hole of the first connecting portion 31311 and the first through holes of the two second connecting portions 31321, the first connecting joint 3131 is rotatably connected to the second connecting joint 3132, and the first connecting joint 3131 is able to rotate 360 degrees relative to the second connecting joint 3132,. Thus, the first folding arm 311 is rotatable relative to the second folding arm 312, so that the first folding arm 311 and the second folding arm 312 are able to be folded and stored in the storage housing 1, and the first folding arm 311 and the second folding arm 312 are able to be unfolded to support and fix the sunshade cloth. The folding assemblies have a simple structure and are convenient to operate.

In one embodiment, the first connecting portion 31311 and the two second connecting portions 31321 are disposed in an I-shaped structure, and the first rotating shaft 3133 is disposed in a middle portion of the I-shaped structure.

In one embodiment, the first rotating assembly 313 further comprises a locking assembly 315 configured to limit a rotating range of the second folding arm 312 relative to the first folding arm 311 with the first rotating shaft 3133 as the rotation center. By configuring the locking assembly 315, the rotation range of the second folding arm 312 relative to the first folding arm 311 is limited, so that the support mechanism 3 stably support and fix the sunshade cloth. When the support mechanism 3 supports the sunshade cloth, the first folding arm 311 and the second folding arm 312 are prevented from rotating relative to each other, avoiding a problem that the support mechanism 3 cannot provide stable support for the sunshade cloth, thereby avoiding a problem that the sunshade cloth being unable to effectively shield sun light and rain. By configuring the locking assembly 315, an overall structure of the vehicle-mounted sunshade device having the support mechanism 3 is made more stable, thereby improving structural stability and reliability of the vehicle-mounted sunshade device.

Optionally, the second connecting joint 3132 comprises a first mounting hole 31322 communicating the first mounting area with an inner cavity of the second folding arm. The locking assembly 315 is mounted in the first mounting hole 31322. The locking assembly 315 comprises a locking rod 3151 and a locking bolt 3152. The locking bolt 3152 runs through the second connecting joint 3132 and the locking rod 3151, so that the locking rod 3151 is rotatable relative to the second connecting joint 3132 with the locking bolt 3152 as a rotation center. The locking rod 3151 is rotatable close to or away from the first connecting portion 31311. The first connecting portion 31311 defines a limiting groove 31312. A locking hook 31511 disposed on an end portion of the locking rod 3151 is placed in the limiting groove 31312. By mounting the locking rod 3151 of the locking assembly 315 to the first mounting hole 31322 of the second connecting joint 3132, and by passing the locking bolt 3152 through the second connecting joint 3132 and the locking rod 3151, the locking rod 3151 is rotatable relative to the second connecting joint 3132 in the first mounting hole 31322 with the locking bolt 3152 as the rotation center. Therefore, the locking rod is able to approach or move away from the first connecting portion 31311, so that the locking hook 31511 disposed on the locking rod 3151 is able to be placed in or out of the limiting groove 31312.

When the vehicle-mounted sunshade device is in the unfolded state, the locking hook 31511 disposed on the locking rod 3151 is placed in the limiting groove 31312 defined in the first connecting portion 31311, thereby limiting a relative rotation between the first folding arm 311 and the second folding arm 312. At this time, an angle between the first folding arm 311 and the second folding arm 312 is maximum, providing stable support for the sunshade cloth, so that the sunshade cloth effectively shields the sun light and rain, and the structural stability and reliability of the vehicle-mounted sunshade device is improves. When the vehicle-mounted sunshade device rotates from the unfolded state to the folded storage state, the locking hook 31511 disposed on the locking rod 3151 moves out of the limiting groove 31312 defined in the first connecting portion 31311, and the first folding arm 311 and the second folding arm 312 are rotatable relative to each other, which is convenient for the user to store. Optionally, when the locking hook 31511 disposed on the locking rod 3151 is placed in the limiting groove 31312 defined in the first connecting portion 31311 and limits the relative rotation between the first folding arm 311 and the second folding arm 312, the angle between the first folding arm 311 and the second folding arm 312 is 180 degrees, making the overall structure of the vehicle-mounted sunshade device regular, which improves the user experience.

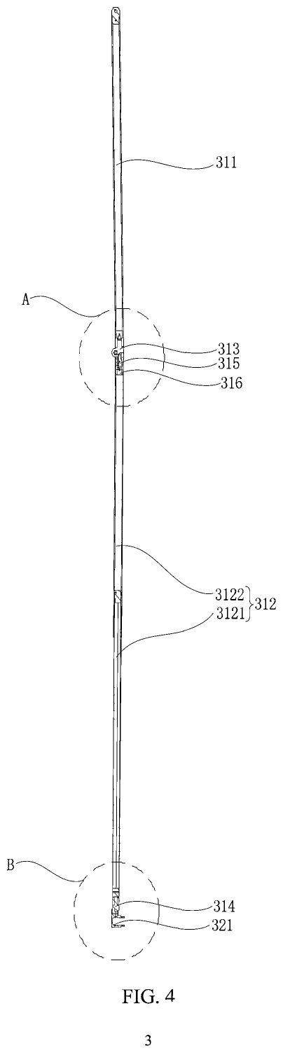

As shown in FIG. 4, the second folding arm 312 comprises an inner retractable rod 3121 and an outer sleeving rod 3122 sleeved on an outer wall of the inner retractable rod 3121. The outer sleeving rod 3122 is connected to the first folding arm 311. The inner retractable rod 3121 is connected to the support assembly 32. The user is able to extend and retract the second folding arm 312 according to his/her own usage requirements and a length of the sunshade cloth. By pulling the inner retractable rod 3121 disposed in the outer sleeving rod 3122, a length of the second folding arm 312 is adjusted, thereby adjusting a length of the vehicle-mounted sunshade device, effectively increasing the application range of the vehicle-mounted sunshade device, and improving the user experience.

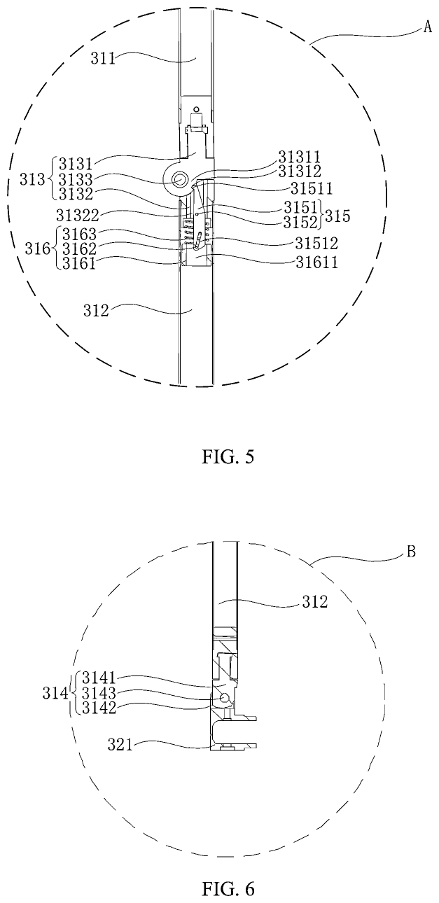

Optionally, as shown in FIG. 5, the first rotating assembly 313 further comprises a limiting assembly 316. The limiting assembly 316 is configured to drive the locking rod 3151 to rotate relative to the second connecting joint 3132. The limiting assembly 316 comprises a sleeve 3161 disposed in the outer sleeving rod 3122, a limiting bolt 3162, and a first elastic piece 3163 disposed between the sleeve 3161 and the second connecting joint 3132. The sleeve 3161 movably abuts against the inner retractable rod 3121. The limiting bolt 3162 runs through the sleeve 6161 and the locking rod 3151. The locking rod 3151 defines a kidney-shaped hole 31512. The kidney-shaped hole 31512 is inclined. The limiting bolt 3162 passes through the kidney-shaped hole 31512. The sleeve defines a second mounting hole configured for placing the locking rod 3151. The kidney-shaped hole that is inclined and configured for the limiting bolt 31512 to pass through is defined in the locking rod 3151, and the limiting bolt 3162 passes through the sleeve 3161 and the locking rod 3151, so that when the sleeve 3161 moves relative to the outer sleeving rod 3122, the limiting bolt 3162 is driven by the sleeve 3161 to move relative to the locking rod 3151 in the kidney-shaped hole 31512 on the locking rod 3151. In addition, the kidney-shaped hole 31512 in the locking rod 3151 is inclined, and the sleeve 3161 has the second mounting hole 31611 for the locking rod 3151 to be inserted. When the locking rod 3151 is inserted into the second mounting hole 31611 of the sleeve 3161, the locking rod 3151 abuts against an inner wall of the second mounting hole 31611. At this time, as the sleeve 3161 moves, the inner wall of the second mounting hole 31611 compresses the locking rod 3151 and drives the locking rod 3151 to rotate relative to the second connecting joint 3132 with the locking bolt 3152 as the rotation center, so that the locking rod 3151 is able to approach or move away from the first connecting portion 31311. As a result, the locking hook 31511 on the locking rod 3151 is placed in or out of the limiting groove 31312, thereby limiting the relative rotation between the first folding arm 311 and the second folding arm 312.

When in the folded storage state, the sleeve 3161 disposed in the outer sleeving rod 3122 abuts against the inner retractable rod 3121, and the inner retractable rod 3121 drives the sleeve 3161 to move relative to the outer sleeving rod 3122 and compresses the first elastic piece 3163 disposed between the sleeve 3161 and the second connecting joint 3132, so that the limiting bolt 3162 moves relative to the locking rod 3151 in the kidney-shaped hole 31512 defined on the locking rod 3151. At the same time, the inner wall of the second mounting hole 31611 of the sleeve 3161 abuts against and compresses the locking rod 3151, driving the locking rod 3151 to rotate relative to the second connecting joint 3132 with the locking bolt 3152 as the rotation center, so that the locking hook 31511 on the locking rod 3151 moves out of the limiting groove 31312, and the restriction on the relative rotation between the first folding arm 311 and the second folding arm 312 is released, which is convenient for the user to store.

When rotating from the folded storage state to the unfolded state, the inner retractable rod 3121 moves away from the sleeve 3161, and the first elastic piece 3163 is reset under an action of its own elastic force and drives the sleeve 3161 to move relative to the outer sleeving rod 3122 in a direction away from the second connecting joint 3132, so that the limiting bolt 3162 moves relative to the locking rod 3151 in the kidney-shaped hole 31512 defined in the locking rod 3151. At the same time, the inner wall of the second mounting hole 31611 of the sleeve 3161 abuts against and compresses the locking rod 3151, thereby driving the locking rod 3151 to rotate relative to the second connecting joint 3132 with the locking bolt 3152 as the rotation center. Thus, the locking hook 31511 on the locking rod 3151 moves into the limiting groove 31312, to limit the relative rotation between the first folding arm 311 and the second folding arm 312. At this time, the folding assemblies provide stable support for the sunshade cloth, so that the sunshade cloth effectively shade the user from the sun light and rain, thereby improving the structural stability and reliability of the vehicle-mounted sunshade device.

When the user needs to fold and store the vehicle-mounted sunshade device in the unfolded state, the user is able to push the support assembly 32 to retract the inner retractable rod 3121 of the second folding arm 312 into the outer sleeving rod 3122 until the inner retractable rod 3121 abuts against the sleeve 3161 disposed in the outer sleeving rod 3122. Then, the inner retractable rod 3121 drives the sleeve 3161 to move relative to the outer sleeving rod 3122 and compresses the first elastic piece 3163 disposed between the sleeve 3161 and the second connecting joint 3132, so that the limiting bolt 3162 moves relative to the locking rod 3151 in the kidney-shaped hole 31512 defined in the locking rod 3151. At the same time, the inner wall of the second mounting hole 31611 of the sleeve 3161 abuts against and compresses the locking rod 3151, thereby driving the locking rod 3151 to rotate relative to the second connecting joint 3132 with the locking bolt 3152 as the rotation center, so that the locking hook 31511 disposed on the locking rod 3151 moves out of the limiting groove 31312, and the relative rotation between the first folding arm 311 and the second folding arm 312 is released. It is noted that two folding assemblies comprises two first folding arms 311 and two second folding arms 312, and the two first folding arms 311 and the two second folding arms 312 that are disposed on the two opposite sides of the roller 21 are rotated from the unfolded state to the folded storage state, and the sunshade cloth is rolled up to an outer surface of the roller 21 under the push of the push rod and the reset and retraction of each second elastic piece, and the support assembly 32 is placed into the cover body 11 through the limiting opening of the storage housing. Then, the user is able to cover the upper cover 114 on the limiting opening of the storage housing 1 to complete the storage of the vehicle-mounted sunshade device. Optionally, the first elastic piece 3163 may be a spring or an elastic sheet disposed between the sleeve 3161 and the second connecting joint 3132.

As shown in FIGS. 2, 4, and 6, in the embodiment, the second rotating assembly 314 comprises a third connecting joint 3141 disposed on a second end portion of the second folding arm 312, a fourth connecting joint 3142 disposed on the support assembly 32, and a second rotating shaft 3143. The second rotating shaft 3143 is rotatably connected to the third connecting joint 3141 and the fourth connecting joint 3142. The third connecting joint 3141 comprises a third connecting portion. The fourth connecting joint 3142 comprises two fourth connecting portions disposed at intervals. A second mounting area for placing the third connecting portion is enclosed between the two fourth connecting portions. The third connecting portion and the two fourth connecting portions comprise second through holes. The second rotating shaft 3143 passes through the second through holes.

By placing the third connecting portion of the third connecting joint 3141 into the second mounting area enclosed by the two fourth connecting portions, and by passing the second rotating shaft 3143 through the second through hole of the third connecting portion and the second through holes of the two fourth connecting portions, the third connecting joint 3141 is rotatably connected to the fourth connecting joint 3142, and the third connecting joint 3141 is rotatable 360 degrees relative to the fourth connecting joint 3142, so that the second folding arm 312 is rotatable relative to the support assembly 32. Therefore, the second folding arm 312 is allowed to be folded and stored in the storage housing 1. Alternatively, the second folding arm 312 is allowed to be unfolded to support and fix the sunshade cloth. The structure of the support mechanism is simple and the operation is convenient.

Optionally, the support mechanism comprises the support assembly 32. The support assembly 32 comprises a support frame 321. The second end portion of the second folding arm 312 of each of the folding assemblies 31 is rotatably connected to support frame 321. At least one support rod 322 is rotatably disposed on the support frame 321. The support frame 321 defines an accommodating area configured to accommodate the at least one support rod 322. When in the unfolded state, the at least one support rod 322 accommodated in the accommodating area of the support frame 321 is rotated to be perpendicular to the ground, so that the at least one support rod 322 abuts against the ground to support the vehicle-mounted sunshade device, which improves the stability and wind resistance of the vehicle-mounted sunshade device. The present disclosure does not limit the specific structure and number of the at least one support rods 322 of the support assembly 32. Optionally, the sat least one support rod 322 is a telescopic rod for easy storage. Optionally, the at least one support rod comprises support rods 322 disposed on the support frame 321, and the support rods 322 are evenly disposed on the support frame 321, which provide a stable supporting force for the vehicle-mounted sunshade device. Optionally, two support rods 322 are provided, and the two support rods 322 are rotatably disposed on two opposite sides of the support frame 321, which provide stable support for the vehicle-mounted sunshade device while being convenient for users to use and store.

As shown in FIGS. 1, 2, and 6, the present disclosure further provides a vehicle-mounted sunshade device. The vehicle-mounted sunshade device comprises a storage housing 1 having an cover body 11, a roller 21 rotatably disposed in the storage housing 1, a sunshade cloth wound on the roller 21, and a support mechanism 3. The support mechanism 3 is configured to support the sunshade cloth when the sunshade cloth is in the unfolded state. The storage housing 1 defines a limiting opening. The limiting opening is configured to communicate the cover body 11 with an outside and allows the sunshade cloth and the support mechanism 3 to pass through. The storage housing 1 comprises a cover body 11 configured to cover the limiting opening. A position of the upper cover is corresponding to the limiting opening. The sunshade cloth comprises a second elastic piece configured to drive the sunshade cloth to be wound onto the roller 21. The support mechanism 3 comprises two folding assemblies 31 respectively disposed on two opposite sides of the roller 21 and a support assembly 32. Each of the folding assemblies 31 comprises a first folding arm 311, a second folding arm 312, a first rotating assembly 313, and a second rotating assembly 314. For ease of illustration, the present disclosure takes one of the folding assemblies for further description. The first folding arm 311 and the second folding arm are rotatably disposed in the storage housing 1. The first rotating assembly 313 is configured to rotatably connect the first folding arm 311 to the second folding arm. The second rotating assembly 314 is configured to rotatably connect the second folding arm to the support assembly 32. A pull rod fixedly connected to the support assembly 32 is disposed on one side of the sunshade cloth away from the roller 21.

When the sunshade cloth needs to be unfolded for use, the user is able to open the upper cover locate above the limiting opening and pull the support assembly 32 of the support mechanism 3, so as to pull the support assembly 32 out of the cover body 11 from the limiting opening on the storage housing 1. While pulling the support assembly 32, the first rotating assembly 313 and the second rotating assembly 314 of each of the folding assemblies 31 are pulled by the external force applied on the support assembly 32, and the first folding arm 311 and the second folding arm of each of the folding assemblies 31 disposed on the two opposite sides of the roller 21 are rotated from the folded storage state to the unfolded state. At the same time, the pull rod disposed on the sunshade cloth and fixedly connected to the support assembly 32 is driven by the support assembly 32 to move out of the cover body 11. In addition, when the pull rod is pulled, the pull rod drives the sunshade cloth to rotate, thereby driving the roller 21 to rotate, so that the sunshade cloth wound on the roller 21 is pulled out of the cover body 11 through the limiting opening. At this time, the second elastic piece on the sunshade cloth is in a stretched state under the action of external force. The two folding assemblies 31 disposed on the opposite sides of the roller 21 and the support assembly 32 support and fix the sunshade cloth, and at this time the sunshade cloth plays a role of sunshade and rainproof.

When the sunshade cloth needs to be stored, the user only needs to pushes the support assembly 32, so that the support assembly 32 is placed into the cover body 11 from the limiting opening of the storage housing 1. At this time, the first folding arm 311 and the second folding arm of each of the folding assemblies 31 that are disposed on the two opposite sides of the roller 21 are rotated from the unfolded state to the folded storage state, and the sunshade cloth is rolled up on the roller 21 under the push of the pull rod and the resetting and retraction of the second elastic piece. Then, the user may cover the upper cover 114 on the limiting opening of the storage housing 1 to complete the storage of the vehicle-mounted sunshade device. By providing the support mechanism 3 configured to support and fix the sunshade cloth on the vehicle-mounted sunshade device, and by using the support mechanism 3 to assist in unfolding and storing the sunshade cloth, the operation is simplified, making it simple for the user to use, and effectively improving the user experience.

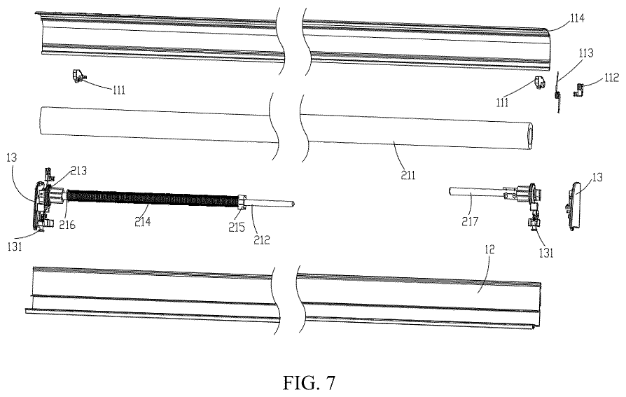

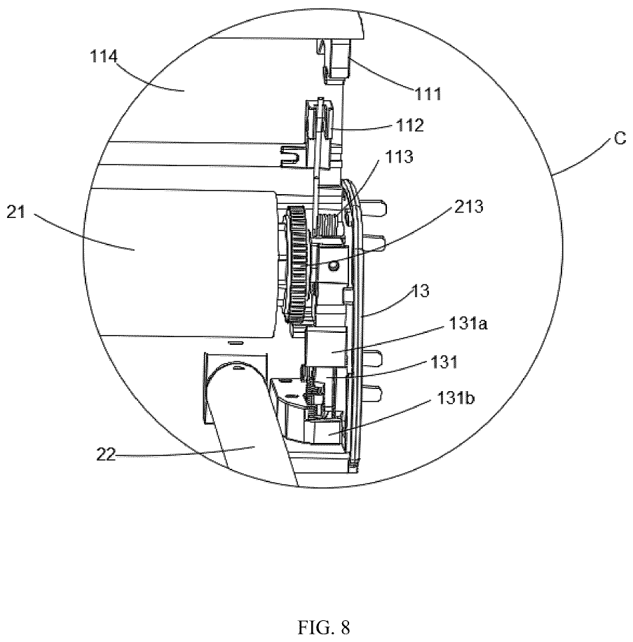

As shown in FIGS. 7-8, the roller 21 is connected to the mounting plates 13 and is placed in the storage housing 1. The two folding assemblies 31 and the support rod 32 is also accommodated in the storage housing 1 when in the folded and storage state.

Furthermore, the cover body 11 comprises an upper cover 114. The upper cover 114 is disposed above the mounting plates 13 and is rotatable relative to the mounting plates 13.

In one embodiment, a length of the upper cover 114 is not less than a length of a fixing plate 12. The upper cover 114 is hinged on an upper side of the fixing plate 12. The mounting plates 13 are respectively fixedly disposed on two ends of the fixing plate 12 along a length direction thereof. The mounting plates 13 are connected to the side surfaces of the fixing plate 12 and the bottom surface of the fixing plate 12. At this time, the mounting plates 13 are also located at two ends of a length direction of the upper cover 114. Such structure enables the storage housing 1 to achieve very good sealing performance.

In one embodiment, in order to facilitate the user to unfold and store the sunshade cloth, a first end (a fixed end) of the sunshade cloth is fixed on the roller 21, and a second end (a free end) of the sunshade cloth is provided with a pull rod 15 along a width direction thereof.

In one embodiment, one end of each of the support rods 32 is connected to the free end of the sunshade cloth through the pull rod 15.

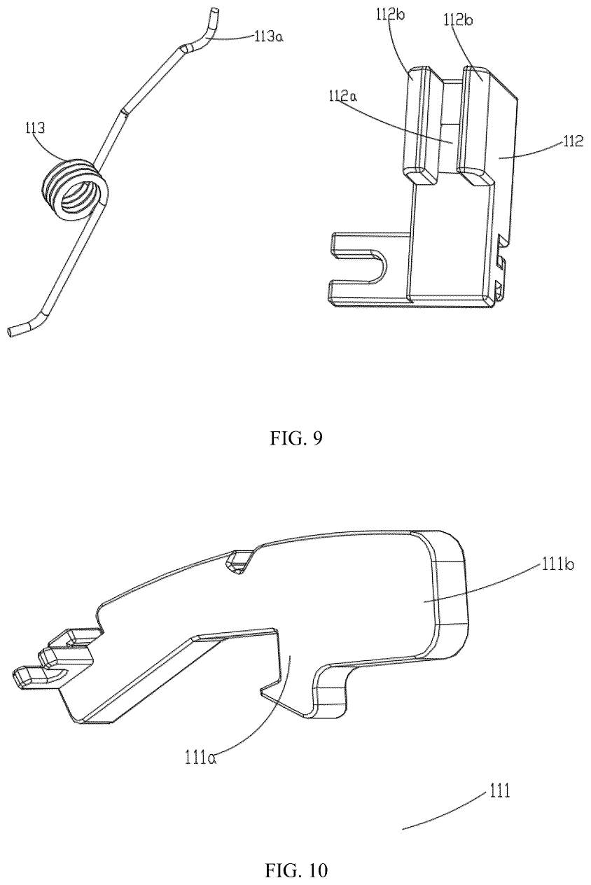

Furthermore, as shown in FIGS. 8-9, the cover body 11 further comprises upper cover spring seats 112 and upper cover springs 113. The upper cover spring seats 112 are disposed on one side of the upper cover 114 close to the roller 21. Each of the upper cover springs 113 is connected to a corresponding one of the mounting plates 13. Each of the upper cover springs 113 abuts against a corresponding one of the upper cover spring seats 112. In this way, when opening the upper cover 114, since the upper cover springs 113 provide upward elastic forces to assist in opening the upper cover 114, the user can easily open the upper cover 114 and fully prop the upper cover 114 open and stand it upright.

As shown in FIG. 9, furthermore, an upper cover spring seat groove 112a is defined in each of the upper cover spring seats 112. Each of the upper cover springs 113 comprises an upper cover spring clamping portion 113a. The upper cover spring clamping portion 113a of each of the upper cover springs 113 is matched with the upper cover spring seat groove 112a of a corresponding one of the upper cover spring seats 112.

In one embodiment, when the upper cover 114 rotates upward relative to the mounting plates 13, the upper cover spring seats 112 rotate upward accordingly, and the upper cover spring clamping portion 113a of each of the upper cover springs 113 gradually enters the upper cover spring seat groove 112a of the corresponding one of the upper cover spring seats 112. When the upper cover spring clamping portion 113a of each of the upper cover springs 113 completely enters the upper cover spring seat groove 112a of the corresponding one of the upper cover spring seats 112, the upper cover is in an open position, the user is able to pull out the sunshade cloth from the storage housing 1. As shown in FIG. 10, at this time, each upper cover spring clamping portion 113a and the corresponding upper cover spring seat groove 112a form a clamping relationship and provide an upward supporting force for the upper cover 114, so that the upper cover 114 only rotates downward after the upper cover 114 is subjected to a force that causes each upper cover spring clamping portion 113a to disengage from the corresponding upper cover spring seat groove 112a. Therefore, even in encountering severe weather such as strong winds and heavy rains, the upper cover 114 is still stably supported, and the upper cover 114 does not accidentally rotate downward and be closed.

In another embodiment, after the sunshade cloth is stored in the storage housing 1, the upper cover 114 rotates downward relative to the mounting plates 13 (i.e., the storage housing 1 is closed), driving the upper cover spring seats 112 to rotate downward synchronously, and each upper cover spring clamping portion 113a gradually leaves the corresponding upper cover spring seat groove 112a. When the upper cover 114 rotates to a closed position, each upper cover spring clamping portion 113a completely disengage from the corresponding upper cover spring seat groove 112a.

In one embodiment, each upper cover spring clamping portion 113a and the corresponding upper cover spring seat groove 112a are arc-shaped, so that each upper cover spring clamping portion 113a is enabled to separate from and enter the corresponding upper cover spring seat groove 112a smoothly without any jamming.

Optionally, in order to avoid each upper cover spring clamping portion 113a and the corresponding upper cover spring seat groove 112a from getting stuck, causing the upper cover 114 to be unable to smoothly rotate downward relative to the mounting plates 13, when each upper cover spring clamping portion 113a enters the corresponding upper cover spring seat groove 112a, an end portion of each upper cover spring 113 is outside the corresponding upper cover spring seat groove 112a.

Optionally, in order to prevent each of the upper cover springs 113 from unnecessarily moving on a contact surface with a corresponding one of the upper cover spring seats 112, each of the upper cover spring seats 112 further comprises two upper cover spring seat blocks 112b, and each of the upper cover springs 113 and the corresponding one of the upper cover spring seats 112 are in contact between the two upper cover spring seat blocks 112b of the corresponding one of the upper cover spring seats 112.

Furthermore, the cover body 11 further comprises upper cover buckles 111 disposed on the upper cover 114. Upper cover switches 131 are respectively disposed on the mounting plates 13. Specifically, the upper cover 114 rotates to abut against the mounting plates 13, and the upper cover buckles 111 are respectively buckled with the upper cover switches 131. At this time, the upper cover 114 is in the closed position.

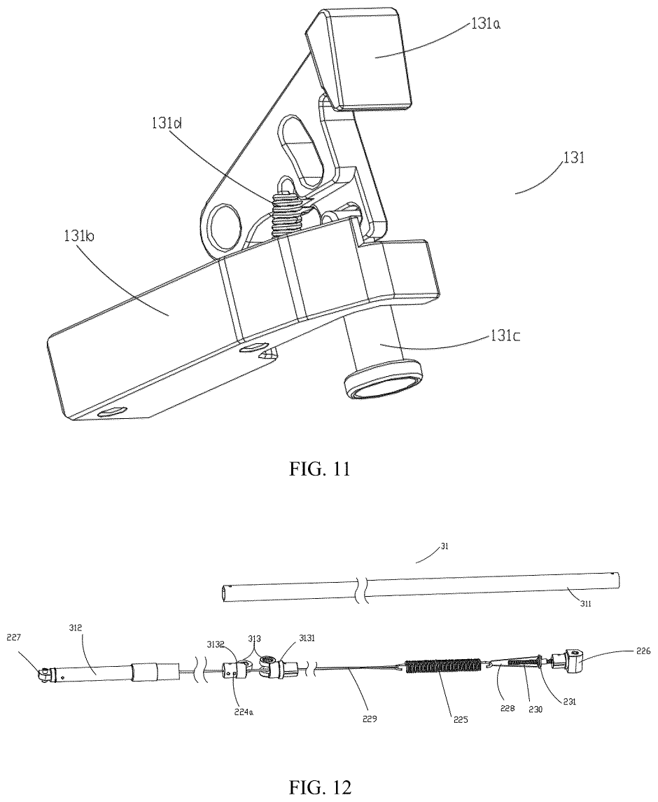

In one embodiment, as shown in FIG. 11, in order to improve the connecting stability of the upper cover buckles 111 and the upper cover switches 131 (i.e., the storage housing 1 is in the closed position), the upper cover buckles 111 comprise buckle hooks 111a and buckle anti-disengagement seats 111b. When the storage housing 1 is in the closed position, the hooks are configured to respectively hook the upper cover switches 131. When the hooks 111a respectively hook on the upper cover switches 131, the buckle anti-disengagement seats 111b contact a bottom surface of the fixing plate 12, thus ensuring that the upper cover buckles 111 are not deformed and disengaged from the upper cover switches 131 even when encountering severe bumps or strong impacts. Therefore, the upper cover 114 is not accidentally opened.

Furthermore, as shown in FIG. 11, the upper cover switches 131 further comprise switch buckles 131a and positioning columns 131b. The positioning columns 131b are configured to connect with the fixing plate 12, and the switch buckles 131a are configured to one-to-one buckle with the upper cover buckles 111. Specifically, when the cover body 11 rotates downward relative to the mounting plates 13 until the upper cover 114 abuts against the mounting plates 13, the hook s111a are one-to-one buckled with the switch buckles 131a.

In the embodiment, as shown in FIG. 11, each of the upper cover switches 131 further comprises switch buttons 131c and switch springs 131d. A first end of each of the switch springs 131d is connected to a corresponding one of the switch buttons 131c, and a second end of each of the switch springs 131d is connected to a corresponding one of the switch buckles 131a. When the user needs to open the upper cover 114, the user only needs to press any one of the switch buttons 131c, and the one switch button 131c controls the corresponding one of the switch buckles 131a to pop up, so that the hooks 111a are respectively separated from the switch buckles 131a, and the user is enabled to rotate the upper cover 114 upward to open the upper cover 114.

In one embodiment, when mounting the positioning columns 131b, spaces are left for the buckle anti-disengagement seats 111b.

Alternatively, in one embodiment, when the upper cover 114 is in the closed position, each of the buckle anti-disengagement seats 111b contacts both the bottom surface of the fixing plate 12 and the corresponding one of the positioning column 131b, so that there is no gap for displacement in a vertical direction between the fixing plate 12 and the upper cover 114. Thus, the upper cover buckles 111 are more stably buckled with the switch buckles 131a.

In one embodiment, a width of the sunshade cloth is approximately the same as a distance between side surfaces of the two positioning columns 131b close to a corresponding one of the folding assemblies 31. By such arrangement, if the sunshade cloth is deflected when the user rolls it up, the user only needs to push one end of the pull rod 15 against a corresponding one of the positioning columns 131b, and the pull rod 15 returns the sunshade cloth to its original position along the corresponding one of the positioning columns 131b. Therefore, the sunshade cloth is easily stored in the storage housing 1 without manual adjustment, which is time-saving and convenient.

In one embodiment, a U-shaped rod is disposed on the pull rod 15, and the U-shaped rod is configured to shield the folding assemblies 31 and the support rod 32 after the folding assemblies 31 and the support rod 23 enter the storage housing 1, so as to prevent the folding assemblies 31 and the support rod 23 from accidentally falling out of the storage housing 1.

In one embodiment, the roller 21 is connected to the mounting plates 13 through gears 213.

Optionally, two gears 213 are provided. The two gears 213 are disposed on two ends of the roller along an axial direction thereof.

Furthermore, the roller 21 comprises a first reel 212 disposed therein.

In one embodiment, the first reel 212 is connected to a first mounting plate 13 on a first axial side of the roller 21 through a first gear 213.

Furthermore, a reel spring 241 is sleeved on an outer circumference of the first reel 212 along an axial direction of the first reel 212. By adjusting a torque of the reel spring 214, the user may set required force of the first reel 212 when rolling the sunshade cloth according to the needs.

In one embodiment, the torque of the reel spring 214 is adjusted by the first gear 213 connected thereto.

In one embodiment, for working stability of a winding sleeve 211, the roller 21 further comprises a second reel 217. The winding sleeve 211 is sleeved on the first reel 212 and the second reel 217, and the second reel 217 is connected to a second mounting plate 13 disposed on a second axial side of the roller 21 through a second gear 213.

Furthermore, as shown in FIG. 7, in order to prevent the reel spring 214 from unnecessarily moving on the first reel 212, a reel fixing piece 215 and a reel washer 216 are disposed on the first reel 212. The reel fixing piece 215 abuts against a first end of the reel spring 214 away from the first gear 213. The reel washer 216 abuts against a second end of the reel spring 214 close to the first gear 213. The reel fixing piece 215 and the reel washer 216 define restricting grooves that match a shape of an inner wall of the winding sleeve 211. As long as the movement of the reel fixing piece 215 and the reel washer 216 on the first reel 212 is limited, the movement of the reel spring 214 on the first reel 212 is limited accordingly.

FIG. 12 is a cross-sectional schematic diagram of a second embodiment of the folding assemblies 31 of the support mechanism 3 of the present disclosure. As shown in FIG. 12, in order to reduce the force required by the user to unfold the sunshade cloth through the folding assemblies 31, a connecting rod spring 225 is disposed inside the first folding arm 311 of each of the folding assemblies 31. A first end of the connecting rod spring 225 is connected to a first connecting piece 226, and a second end of the connecting rod spring 225 passes through the first connecting joint 3131, the second connecting joint 3132 and is connected to the second connecting piece 227 disposed on a second end of the first folding arm of each of the folding assemblies 31.

In one embodiment, in order to facilitate mounting of the connecting rod spring 225 of each of the folding assemblies 31 and adjust the tension of the connecting rod spring 225, a first end of the connecting rod spring 225 of each of the folding assemblies 31 is connected to the first connecting piece 226 thereof through the first connecting rod spring fixing piece 228, and a second end of the connecting rod spring 225 of each of the folding assemblies 31 is connected to the second connecting joint 3132 through a second connecting rod spring fixing piece 229.

Optionally, each first connecting rod spring fixing piece 228 is a triangular metal hook, and each second connecting rod spring fixing piece 229 is a thin steel rope.

In one embodiment, in each of the folding assemblies 31, when mounting the second connecting rod spring fixing piece 229, the first connecting piece thereof 226 is connected to the first connecting rod spring fixing piece 228 through a connecting rod spring screw 230, and the first connecting piece 226 is rotatable relative to the first folding arm 221. By rotating the first connecting piece 226, the tension of the connecting rod spring 225 is adjusted.

In one embodiment, the connecting rod spring screw 230 axially passes through the first connecting piece 226.

In one embodiment, in each of the folding assemblies 31, a limiting boss is disposed on an inner wall of the first folding arm 311, a connecting rod spring washer 231 is disposed on a connection area between the connecting rod spring screw 230 and the first mounting piece 228, and the connecting rod spring washer 231 defines a groove corresponding to the limiting boss. In each of the folding assemblies 31, when the connecting rod spring 225 is mounted, the connecting rod spring washer 231 limits the first mounting piece 228 from rotating in the first folding arm 221.

Specifically, in each of the folding assemblies 31, when mounting the connecting rod spring 225, the first end of the connecting rod spring 225 is connected to the first connecting rod spring fixing piece 228, then the first connecting rod spring fixing piece 228 is connected to the first connecting piece 226 through the connecting rod spring screw 230, and the second end of the connecting rod spring 225 is connected to the first end of the second connecting rod spring fixing piece 229. Then, the second end of the second connecting rod spring fixing piece 229 passes through an interior of the first connecting joint 3131, enters an junction of the first connecting joint 3131 and the second connecting joint 3132 outside the first connecting joint 3131, and enters an interior of the second connecting joint 3132. The, the second end of the second connecting rod spring fixing piece 229 passes through the interior of the second connecting joint 3132 and extends out of the second connecting joint 3132 from a connecting hole 224a. Finally, the second end of the second connecting rod spring fixing piece 229 is adjusted to a suitable length and is fixed with a bolt to complete the mounting of the connecting rod spring 225. After the mounting is completed, the tension of the connecting rod spring 225 is adjusted to a suitable size by rotating the first connecting piece 226.

The above are only optional embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. A support mechanism of a vehicle-mounted sunshade device, wherein the vehicle-mounted sunshade device comprises a storage housing having a cover body, a roller rotatably disposed in the storage housing, a sunshade cloth wound on the roller, and the support mechanism; wherein the support mechanism is configured to support the sunshade cloth when the sunshade cloth is in an unfolded state, the storage housing defines a limiting opening communicating the cover body with an outside and allowing the sunshade cloth and the support mechanism to pass through; wherein the support mechanism comprising:
two folding assemblies respectively disposed on two opposite sides of the roller; and
a support assembly;
wherein each of the folding assemblies comprises a first folding arm, a second folding arm, a first rotating assembly, and a second rotating assembly,
wherein the first folding arm and the second folding arm are rotatably disposed in the storage housing, the first rotating assembly is configured to rotatably connect the first folding arm to the second folding arm, the second rotating assembly is configured to rotatably connect the second folding arm to the support assembly, and a pull rod fixedly connected to the support assembly is disposed on one side of the sunshade cloth away from the roller.

2. The support mechanism according to claim 1, wherein the first rotating assembly comprises a first connecting joint disposed on an end portion of the first folding arm, a second connecting joint disposed on an end portion of the second folding arm, and a first rotating shaft rotatably connected to the first connecting joint and the second connecting joint;
wherein the first connecting joint comprises a first connecting portion, the second connecting joint comprises two second connecting portions disposed at intervals, a first mounting area for placing the first connecting portion is enclosed between the two second connecting portions, the first connecting portion and the two second connecting portions comprise first through holes, and the first rotating shaft passes through the first through holes.

3. The support mechanism according to claim 2, wherein the first rotating assembly further comprises a locking assembly configured to limit a rotating range of the second folding arm, the second connecting joint comprises a first mounting hole communicating the first mounting area with an inner cavity of the second folding arm, and the locking assembly is mounted in the first mounting hole;
wherein the locking assembly comprises a locking rod and a locking bolt, the locking bolt runs through the second connecting joint and the locking rod, so that the locking rod is rotatable relative to the second connecting joint with the locking bolt as a rotation center, and the locking rod is rotatable close to or away from the first connecting portion;
wherein the first connecting portion defines a limiting groove, and a locking hook disposed on an end portion of the locking rod is placed in the limiting groove.

4. The support mechanism according to claim 3, wherein the second folding arm comprises an inner retractable rod and an outer sleeving rod sleeved on an outer wall of the inner retractable rod, the outer sleeving rod is connected to the first folding arm, and the inner retractable rod is connected to the support assembly.

5. The support mechanism according to claim 4, wherein the first rotating assembly further comprises a limiting assembly, and the limiting assembly is configured to drive the locking rod to rotate relative to the second connecting joint,
wherein the limiting assembly comprises a sleeve disposed in the outer sleeving rod, a limiting bolt, and a first elastic piece disposed between the sleeve and the second connecting joint;
wherein the sleeve movably abuts against the inner retractable rod, the limiting bolt runs through the sleeve and the locking rod, the locking rod defines a kidney-shaped hole, the kidney-shaped hole is inclined, the limiting bolt passes through the kidney-shaped hole, and the sleeve defines a second mounting hole configured for placing the locking rod.

6. The support mechanism according to claim 1, wherein the second rotating assembly comprises a third connecting joint disposed on an end portion of the second folding arm, a fourth connecting joint disposed on the support assembly, and a second rotating shaft;
wherein the second rotating shaft is rotatably connected to the third connecting joint and the fourth connecting joint, the third connecting joint comprises a third connecting portion, the fourth connecting joint comprises two fourth connecting portions disposed at intervals, a second mounting area for placing the third connecting portion is enclosed between the two fourth connecting portions, the third connecting portion and the two fourth connecting portions comprise second through holes, and the second rotating shaft passes through the second through holes.

7. The support mechanism according to claim 1, wherein the support assembly comprises a support frame rotatably connected to an end portion of the second folding arm of each of the folding assemblies, at least one support rod is rotatably disposed on the support frame, and the support frame defines an accommodating area configured to accommodate the at least one support rod.

8. The support mechanism according to claim 1, wherein a connecting rod spring is disposed inside the first folding arm, a first end of the connecting rod spring is connected to a first connecting piece, and a second end of the connecting rod spring is connected to the second folding arm through the first folding arm.

9. A vehicle-mounted sunshade device, comprising:
the support mechanism according to claim 1,
wherein the storage housing comprises the cover body and mounting plates, the cover body comprises an upper cover, and the upper cover is disposed above the mounting plates and is rotatable relative to the mounting plates;
wherein the cover body further comprises upper cover spring seats and upper cover springs, the upper cover spring seats are disposed on the upper cover, an upper cover spring seat groove is defined in each of the upper cover spring seats, each of the upper cover springs is connected to a corresponding one of the mounting plates, each of the upper cover springs comprises an upper cover spring clamping portion, the upper cover spring clamping portion of each of the upper cover springs is matched with the upper cover spring seat groove of a corresponding one of the upper cover spring seats, and when the upper cover rotates upward to an open position relative to the mounting plates, the upper cover spring clamping portion of each of the upper cover springs completely enters the upper cover spring seat groove of the corresponding one of the upper cover spring seats.

10. The vehicle-mounted sunshade device according to claim 9, wherein the cover body further comprises upper cover buckles disposed on the upper cover, upper cover switches are respectively disposed on the mounting plates, and when the cover body is rotated downward relative to the mounting plates until the upper cover abuts against the mounting plates, each of the upper cover buckles is engaged with a corresponding one of the upper cover switches;
wherein the vehicle-mounted sunshade device further comprises a fixing plate disposed below the upper cover, the upper cover buckles comprises buckle anti-disengagement seats, and when each of the upper cover buckles is engaged with the corresponding one of the upper cover switches; the buckle anti-disengagement seats abuts against the fixing plate.

11. The vehicle-mounted sunshade device according to claim 10, wherein the upper cover switches are connected to the fixing plate through positioning columns.

12. The vehicle-mounted sunshade device according to claim 9, wherein the roller is connected to the mounting plates through gears, a first reel is disposed inside the roller, and a reel spring is sleeved on an outer circumference of the first reel along an axial direction of the first reel.
